(19) United States
(12) Patent Application Publication
(10) Pub. No.: US 2026/0002761 A1
(43) Pub. Date: Jan. 1, 2026

(54) TARGET HANGER, STAND AND HOOKS

(71) Applicant: War Labs LLC, Lancaster, NY (US)

(72) Inventor: Cameron Chomen, Depew, NY (US)

(21) Appl. No.: 19/251,151

(22) Filed: Jun. 26, 2025

Related U.S. Application Data
(60) Provisional application No. 63/664,326, filed on Jun. 26, 2024.

(51) Int. Cl. F41J 1/10; F16M 11/04; F16M 11/24

(52) U.S. Cl. CPC F41J 1/10; F16M 11/041; F16M 11/242

(57) ABSTRACT

A target hanger includes a hanger body having a top plate and a bottom plate spaced apart by a first side plate and a second side plate. The first side plate and the second side plate define a gap therebetween to receive a support member therein to mount the target hanger on the support member. One or both of the top plate and the bottom plate define an aperture therethrough where the aperture coincides with the gap to allow passage of the support member through the aperture. One or both of the top plate and the bottom plate further define a plurality of slots proximate a peripheral edge of the top plate and/or the bottom plate. Each slot of the plurality of slots selectively receives a target mount therein to present the target to a user.

### CROSS REFERENCE TO RELATED APPLICATIONS

The present application claims the benefit of U.S. provisional patent application 63/664,326 filed Jun. 26, 2024, entitled TARGET HANGER, STAND AND HOOKS, the entire disclosure of which is hereby incorporated by reference.

### TECHNICAL FIELD

The presently disclosed subject matter relates generally to target systems for shooting and shooting ranges, and, more specifically, to target hangers, target stands, target hooks and paper target holders.

### BACKGROUND

The target hanger, stand and system described herein may be used for target shooting, competition shooting and training (e.g. LEO/MIL (law enforcement officer/military personnel); concealed carry). The apparatus and system may be suitable for multiple use cases. In one aspect, the apparatus and system is also modular making upgrading to meet a user's needs or replacing parts easier than requiring the purchasing a whole new unit.

The legs of the target stand described herein fold up into a travel/storage position, so the stand or base is easy to transport and store. The footprint in the travel position is less than half the footprint of the stand in the deployed orientation. In addition, the stand may be mounted on a 2×4 so that the target system can be moved in one trip instead of multiple trips. In one embodiment, the target stand/base may also account for uneven ground. Articulating legs allow the stand to sit level on any terrain so targets are less likely to fall over when hit by projectiles. The device and system are also sturdy enough to withstand the force of wind while also not falling over due to the weight of multiple targets mounted on the apparatus. In addition, the target stand and target hanger described herein may be adaptable. That is, components of the system may be easily replaceable and upgradable to grow with the consumer so as to continue to fit the consumer's needs as they progress along their shooting journey.

In one aspect, the target hanger allows shooters to not only hang almost any size target, typically steel plates or paper, but to also hang multiple target pieces in multiple directions. This allows a shooter to direct shrapnel away from them if they are close while also allowing the hanging of multiple targets on one hanger for an endless number variations of shooting drills which may then lead to better training. The target hanger also allows for switching targets out in seconds, requiring no tools or bolts, including rapidly switching from steel targets to paper targets. In certain embodiments, hanger plates are cut with slots and/or holes for mounting with steel hooks and paper hangers. This hanger design is purposefully repetitive about its periphery such that, if a target hanger somehow damaged at one location, additional options exist for use so that the shooter may continue training.

### BRIEF SUMMARY

With parenthetical reference to corresponding parts, portions or surfaces of the disclosed embodiment, merely for the purposes of illustration and not by way of limitation, the present disclosure provides an exemplary embodiment of a target stand or base (101), a target hanger (201), and various target hooks and mounts (301, 401, 501).

### BRIEF DESCRIPTION OF THE DRAWINGS

The drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a view of an exemplary embodiment of a target system in accordance with the present invention and including a target stand or base with legs in the extended/open position, a target hanger, and target hooks and mounts.

FIG. 2 is a view of the exemplary embodiment of target system shown in FIG. 1 with the target stand or base having its legs in the storage position, along with the target hanger, and target hooks and mounts.

FIG. 3 is a side view of an embodiment of a target stand or base, with legs in the storage position.

FIG. 4 is another side view of an embodiment of a target stand or base, with legs in the storage position.

FIG. 5 is side view of an embodiment of a target stand or base, with three legs in the storage position and one leg in the extending position.

FIG. 6 is a top view of an embodiment of a target stand or base, with each of the legs in the storage position.

FIG. 7 shows an embodiment of a target stand or base with each of the legs in the extended position, together with a support member, such as a standard 2×4.

FIG. 8 shows the modular components of an embodiment of a target stand or base.

FIG. 9 is a perspective view of an embodiment of a target hanger.

FIG. 10 is an expanded top perspective view of the embodiment of a target hanger shown in FIG. 9.

FIG. 11 shows the modular components of the embodiment of a target hanger.

FIG. 12 is a perspective view of an embodiment of a target hook.

FIG. 13 is a perspective view of an embodiment of a drop hook.

FIG. 14 is a side view of an embodiment of a paper target hanger.

FIG. 15 is an expanded perspective view of an adjustment mechanism in the embodiment of a paper target hanger shown in FIG. 14.

FIG. 16 is another view of a target hanger and target hook mounted on a support member.

FIG. 17 is a view of a target stand or base, in combination with a target hanger and drop hook.

FIG. 18 is a view of a target hanger and paper target holder mounted on a support member.

FIG. 19 is an expanded view of the target hanger and paper target holder shown in FIG. 18.

FIG. 20 is a view of a target hanger and paper target holder, holding a paper target.

FIG. 21 is an expanded view of a target hanger and target hook, holding a steel target.

FIG. 22 is an image of a target stand or base, connected with target hangers and three target hooks, each holding a different steel target.

FIG. 23 is a side view of an alternative embodiment of a target stand or base, with legs in the storage position.

FIG. 24 is a side view of the alternative embodiment of a target stand or base shown in FIG. 23, with legs in an extended position.

FIG. 25 is an expanded view of the alternative embodiment of a target stand or base shown in FIG. 24.

FIG. 26 is a front perspective view of an alternative embodiment of a target hanger.

FIG. 27 is a side perspective view of the alternative embodiment of a target hanger shown in FIG. 26.

### DETAILED DESCRIPTION OF THE EMBODIMENTS

It is to be understood that the invention may assume various alternative components, compositions, configurations, systems and orientations, except where expressly specified to the contrary. It is also to be understood that the specific components, compositions, systems and configurations illustrated in the drawings and described herein are simply exemplary embodiments of the inventive concepts defined herein. Hence, specific dimensions, directions, orientations, proportions or other physical characteristics relating to the embodiments disclosed are not to be considered as limiting, unless expressly stated otherwise. Also, although they may not be, like elements in various embodiments described herein may be commonly referred to with like reference numerals within this section of the application.

It is to be appreciated that the present teaching is by way of example only, not by limitation. The concepts herein are not limited to use or application with a specific system or method. Thus, although the instrumentalities described herein are for the convenience of explanation, shown and described with respect to exemplary embodiments, it will be appreciated that the principles herein may be applied equally in other types of target/shooting systems.

Where they are used herein, the terms “first”, “second”, and so on, do not necessarily denote any ordinal, sequential, or priority relation, but are simply used to more clearly distinguish one element or set of elements from another, unless specified otherwise.

### Target System

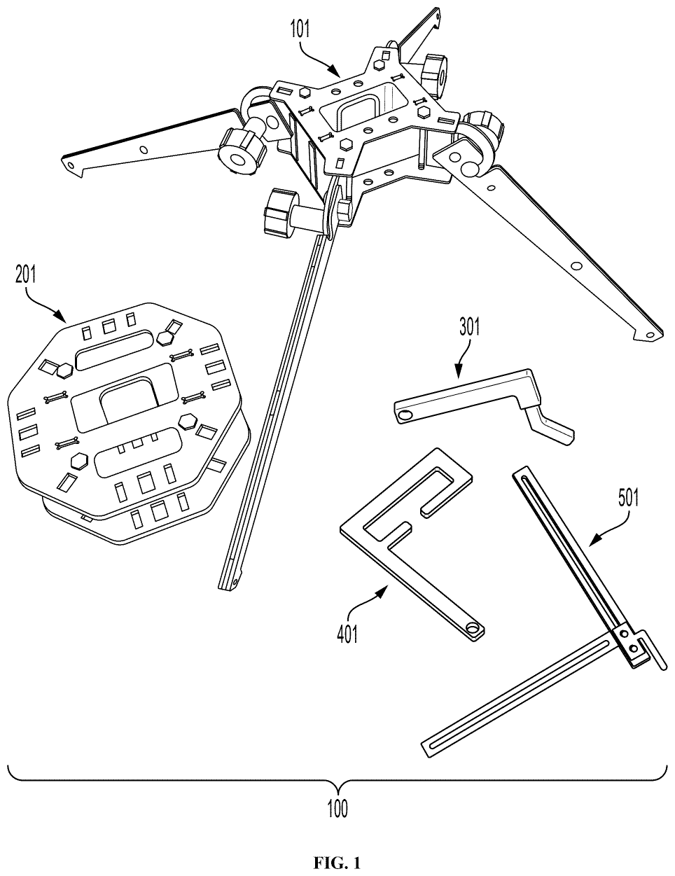

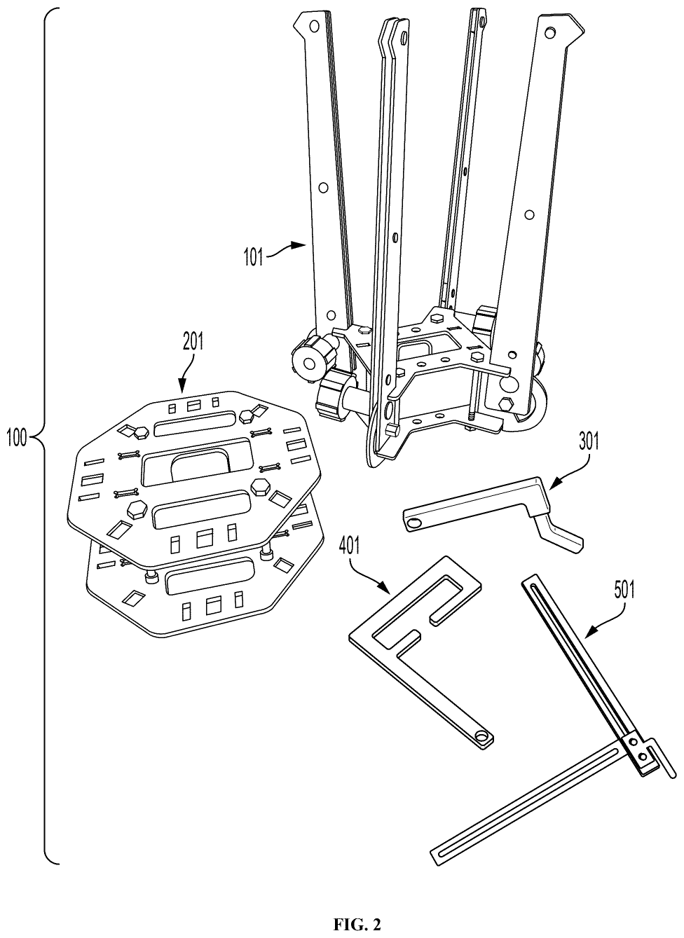

With reference to FIGS. 1 and 2, an exemplary embodiment of a target system (100) may generally include a target stand or base (101), a target hanger (201), and various target hooks and mounts (301, 401, 501), each of which will be described in greater detail below.

### Target Stand/Base

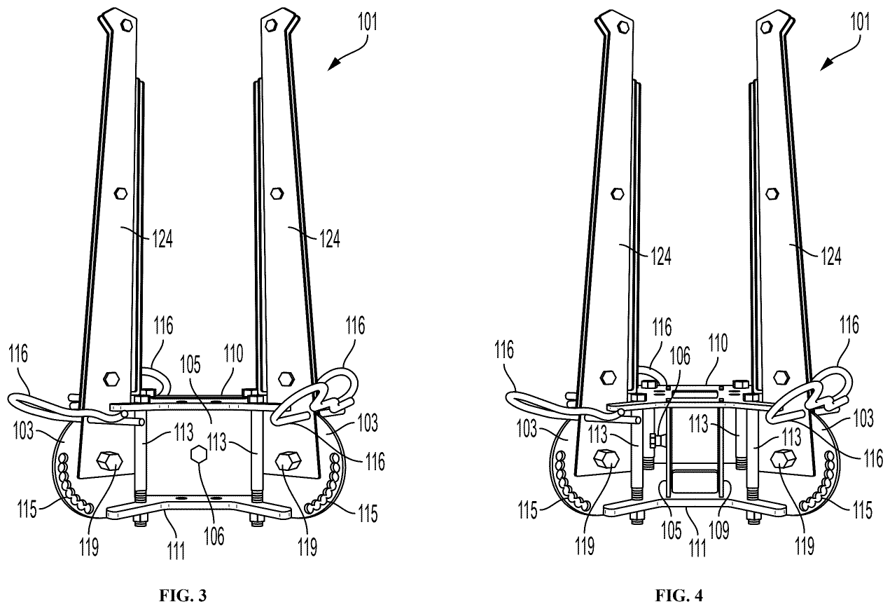

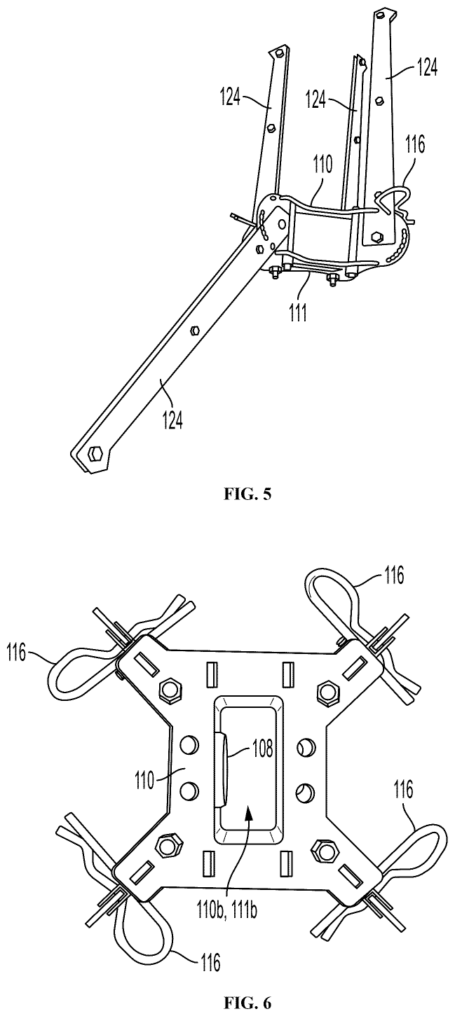

With reference to FIGS. 1-8, target system (100) may include an exemplary target stand or base (101). Exemplary stand (101) generally includes a first side plate (105) and a second side plate (109). First side plate (105) may include a drilled and tapped hole (105b) configured to removably receive a screw or bolt (106). First side plate (105) works in conjunction with a tension plate or spring plate (108) via bolt (106) to adjust tension on an associated support member (107), such as but not limited to a common wood 2×4. In one aspect of the invention, stand (101) may be connected along any part of support member (107). Second side plate (109) may be further customized to include branding information.

Stand (101) may further include a top plate (110) and a bottom plate (111). In one aspect, top plate (110) and bottom plate (111) may be identical to promote interchangeability and ease of construction of stand (101). Each of top plate (110) and bottom plate (111) may include respective side plate slots (110a) and (111a) designed to receive corresponding respective tabs (105a) and (109a) on first side plate (105) and second side plate (109). Top plate (110), bottom plate (111), first side plate (105), and second side plate (109) may then be secured together, such as via one or more screws or nuts and bolts (113).

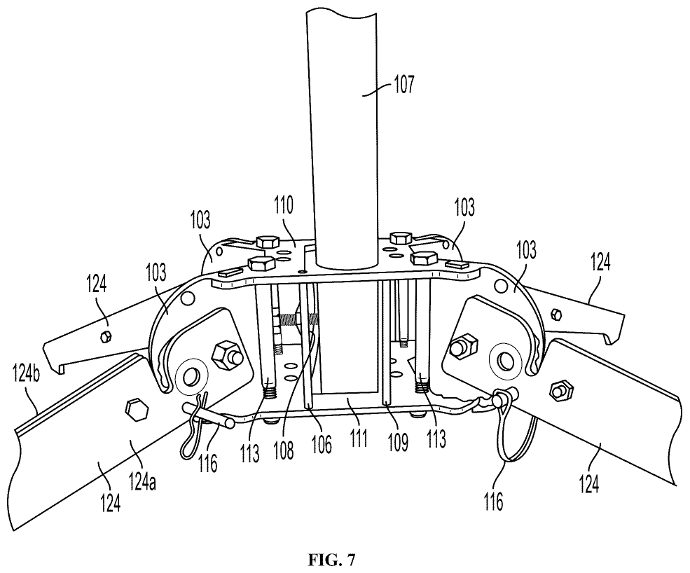

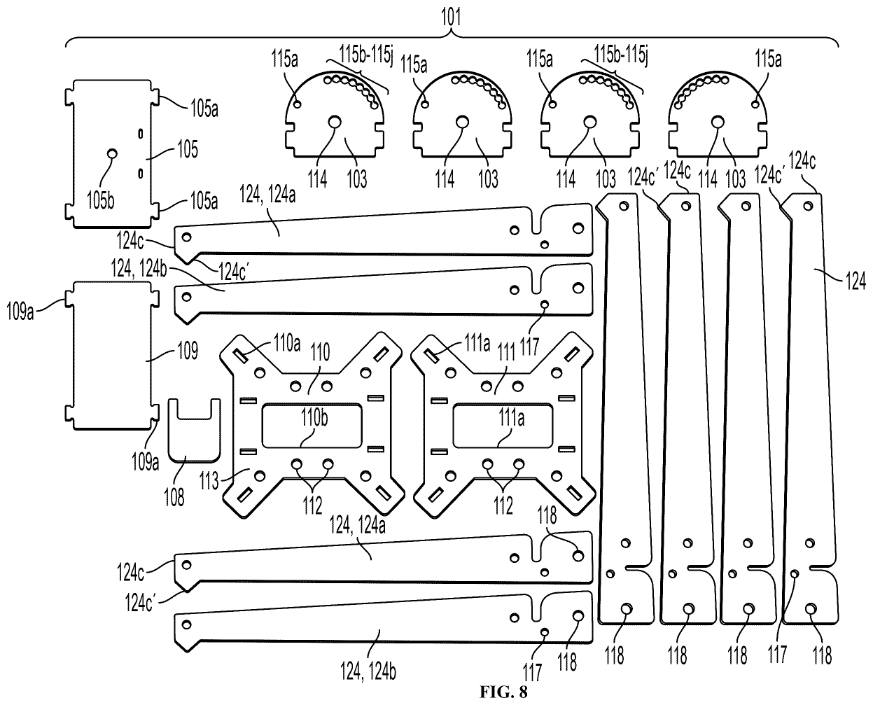

As shown in FIGS. 7 and 8, each of top plate (110) and bottom plate (111) may include a respective aperture (110b), (111b) dimensioned to receive support member (107) therethrough. By way of example and without limitation, each aperture (110b), (111b) may be a 2×4 sized hole cut in the center of each of top plate (110) and bottom plate (111). In addition to apertures (110b), (111b), each of top plate (110) and bottom plate (111) may further include a plurality of small apertures (112), such as but not limited to four ⅜ inch diameter holes, with two holes on either side of aperture (110b), (111b), see also FIG. 6. Small apertures (112) are reserved for current and future accessories/features to mount onto the target stand (101).

Positioned between the top plate (110) and bottom plate (111) are leg brackets (103) By way of example and without being limited thereto, each leg bracket (103) may be shaped similar to a half-circle or half-ellipse. Each respective leg bracket (103) may be mounted on a respective corner of stand (101), and further and without limitation thereto, to a respective corner lobe of top plate (110) and bottom plate (111). Each respective leg bracket (103) is used to attach a respective leg (124) to the base/stand (101). Each respective leg bracket (103) has a central aperture (114) and each respective leg (124) includes a corresponding aperture (118). Apertures (114) and (118) may be configured to receive a bolt or pin (119) therethrough to pivotally mount each leg (124) onto a leg bracket (103).

Each respective leg (124) may include a travel pin aperture (117) proximate aperture (118) and each respective leg bracket (103) may include a plurality of positioning apertures (115). Apertures (117) and (115) may be adjustably located relative to one another to selectively and individually position each respective leg (124) relative to its respective leg bracket (103), and thus top plate (110) and bottom plate (111). By way of example, to secure stand (101) its travel position (FIGS. 1-3 and 5), travel pin aperture (117) may be aligned with aperture (115a) on leg bracket (103) so that leg (124) may be folded vertically with pin (116) being placed through the corresponding apertures (117)/(115a) to hold leg (124) upright for storage or travel. Pin (116) may be secured in place using any suitable fastener or device, such as but not limited to a clevis pin or cotter pin. In one aspect of the invention, leg bracket (103) may include a plurality of positioning apertures (115), such as but not limited to nine apertures (115b)-(155j) so as to allow legs (124) to fold down and be held into place with using pin (116). The exemplary nine different apertures (115b)-(115j) may be used to selectively and independently adjust each respective leg (124) based on the terrain and environment so as to hold stand (101) firmly in place while in use.

In one aspect of the invention legs (124) may be comprised of two subunits (124a), (124b) that are bolted or otherwise secured together along the length of leg (124). As described above, a first aperture (118) may allow leg subunits (124a), (124b) to be rotatably bolted onto leg bracket (103) and thus to stand (101). In certain embodiment, at each point where the leg subunits (124a), (124b) are bolted together (besides at leg bracket (103)), there is a replaceable spacer (not shown) therebetween to create a gap between subunits (124a), (124b). At or proximate to the terminal end (124c) of each leg, there may be a small point (124c′) defined by the leg (124) which may to bite into the ground to help level the stand (101) and keep it sturdy. In a further aspect of the invention bolt (121) proximate terminal end (124c) may allow for additional accessories, such as a larger pad (not shown) to be bolted to leg (124). The pad may be used if the stand (101) is used in an environment where it is not desirable for legs (124) to penetrate the ground or sink into it during use at the range, for example.

It should be noted that stand (101) may be fabricated from one or more suitable materials, such as metal, composite or polymer. In one aspect, stand (101) is formed of mild steel and/or 3D printed parts.

### Target Hanger

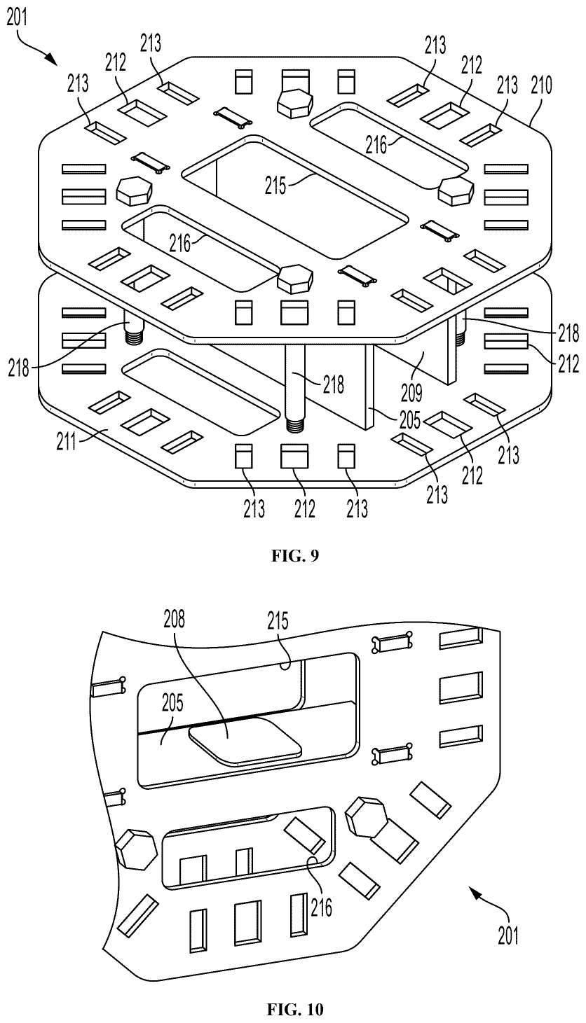

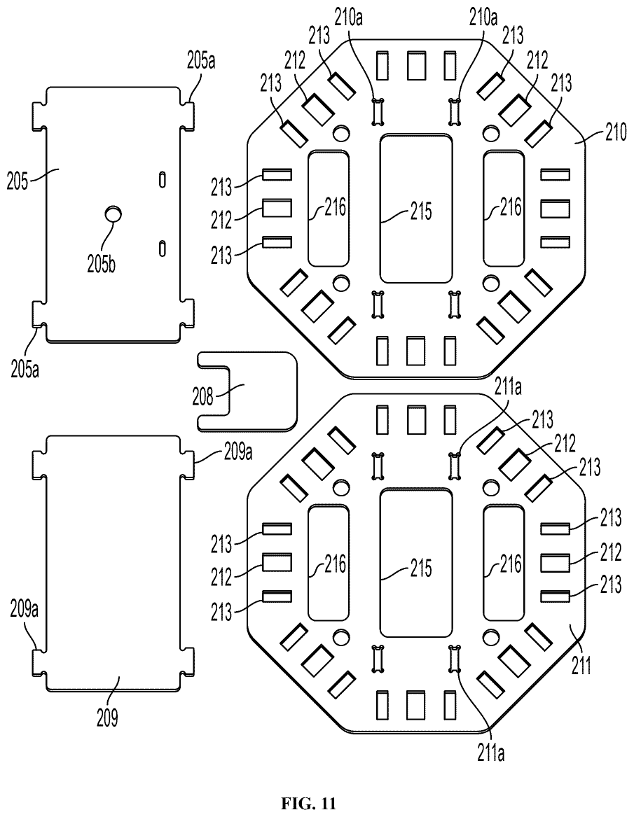

Returning now to FIGS. 1 and 2, along with FIGS. 9-11, target system (100) further includes a target hanger (201) which may be used to hang steel, paper, and other targets as will be described in greater detail below. In an exemplary embodiment, target hanger (201) comprises a hanger subassembly including a first side plate (205) and a second side plate (209). First side plate (205) may include a drilled and tapped hole (205b) configured to removably receive a screw or bolt (106). First side plate (105) works in conjunction with a tension plate or spring plate (108) via bolt (106) to adjust tension on an associated support member (107), such as but not limited to a common wood 2×4. In one aspect of the invention, target hanger (201) may be connected along any part of support member (107). Second side plate (209) may be further customized to include branding information.

Hanger (201) may further include a top plate (210) and a bottom plate (211). In one aspect, top plate (210) and bottom plate (211) may be identical to promote interchangeability and case of construction of hanger (201). Each of top plate (210) and bottom plate (211) may include respective side plate slots (210a) and (211a) designed to receive corresponding respective tabs (205a) and (209a) on first side plate (205) and second side plate (209). Top plate (210), bottom plate (211), first side plate (205), and second side plate (209) may then be secured together, such as via one or more screws or nuts and bolts (218), see FIG. 9. First side plate (205) may also include a drilled and tapped hole (205b) configured to removably receive a screw or bolt (206). In certain embodiments, 3D-printed tubes may be configured snap onto the bolts to protect the bolts from potential impacts while also preventing over-tightening of bolts (218). In one embodiment, the 3D tubes may only be printed at 80% completion of a full circle, e.g., generally C-shaped, to allow them to snap into place while target hanger (201), thus not requiring sliding the tubes onto bolts (218) prior to assembly.

Similar to first plate (105) described above with reference to stand (101), first side plate (205) of hanger (201) works in conjunction with a tension plate or spring plate (208) via bolt (206) to adjust tension on an associated support member (107). In one aspect of the invention, hanger (201) may be connected along any part of support member (107).

In one aspect, top plate (210) and bottom plate (211) are identical and can be readily swapped. While top plate (210) and bottom plate (211) may be formed to any desired geometry, in certain embodiments top plate (210) and bottom plate (211) are octagonal. The face of each of top plate (210) and bottom plate (211) may include a plurality of apertures proximate the side edges of the octagon. By way of example, a larger central aperture (212) may accept target hooks and drop hooks (described below) while flanking smaller slots (213) evenly spaced on either side of the larger central aperture (212) may be configured to receive the paper target hanger (described below). Thus, in the exemplary embodiment shown, there are eight central aperture (212) for hooks and 16 smaller slots (213) for a paper target holder. It should be noted that other geometries may be used, such as but not limited to circle, squares, or hexagons, and alternative aperture/slot configurations may be used depending upon the desired functionality of the resultant target hanger.

As further shown in FIGS. 1, 2, and FIGS. 9-11, top plate (210) and bottom plate (211) may each include a plurality, e.g., three as shown, larger additional apertures (215), (216). By way of example and without limitation, each aperture (215) may be a 2×4 sized hole cut generally in the center of each of top plate (210) and bottom plate (211) to allow passage of support member (107), e.g., a 2×4 to pass through the hanger (201) to a desired position wherein hanger (201) will be secured in position via tension plate or spring plate (208) and bolt (206) as described above. In addition to apertures (215), each of top plate (210) and bottom plate (211) may further include one or more additional apertures (216) which may provide a handle to carry the target hanger, as well as promote weight reduction of hanger (201).

### Target Hook

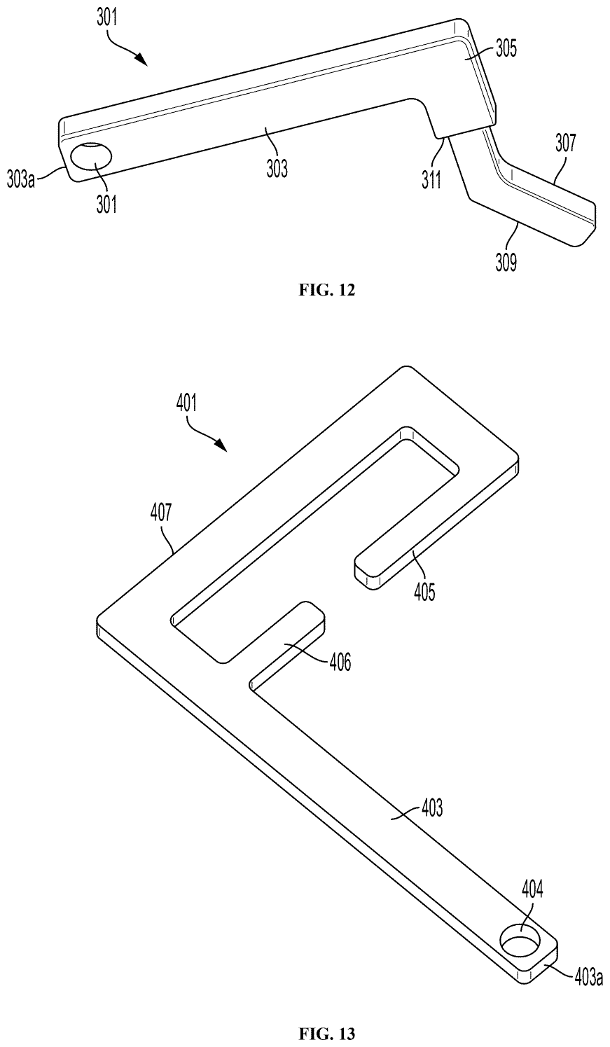

With particular reference to FIG. 12, target system (100) may include one or more target hooks (301). As shown in FIG. 12, an exemplary target hook (301) may include a mounting end (303) designed to fit within aperture (212) on the top plate (210) and bottom plate (211) while allowing for some play therebetween. Proximate the terminal end (303a) of mounting end (303) is an aperture (304) which is configured to receive a pin (not shown) therethrough to retain target hook (301) within apertures (212) and prevent dislodging of target hook (301) during travel or when moving the target system (100) on the range. An elbow portion (305) is dimensioned to seat against top plate (210). Hanger end (307) may extend outward from elbow portion (305) and include a bent portion (309). Hanger end (307) may have a smaller cross-sectional dimension than elbow portion (305) so as to define a shoulder (311) at their junction.

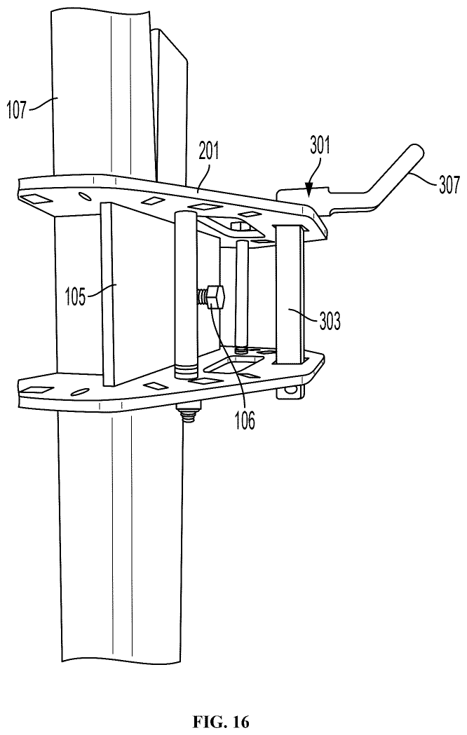

As shown in FIGS. 16, 21, and 22, target hook (301) is configured to removably mount a target (601), such as a steel plate, thereon. Target (601) may slide over hanger end (307) and rest against shoulder (311) a spaced distance from hanger (201) while bent portion (309) prevents accidental dislodging of target (601). Thus, shoulder (311) and bent portion (309) are spaced so that when the target (601) is hit with a bullet there is room for target (601) to move and swing, thereby absorbing the more impact than a static plate. This energy absorption may make it safer for the shooter by reducing the likelihood of ricochets from shrapnel. With the hook design and fitment allowing the target (601) to absorb more impact, it also helps prolong the life of the target (601) and the life of the target system (100).

### Drop Hook

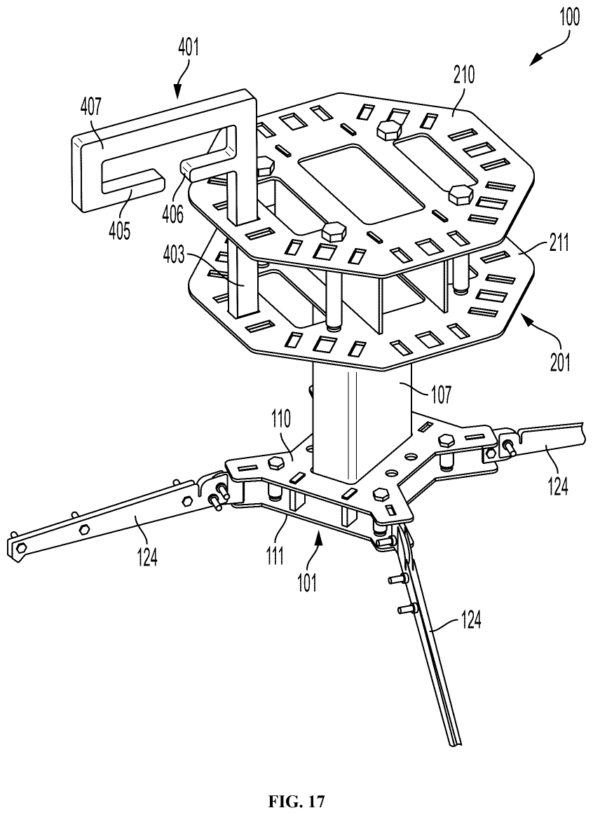

With particular reference to FIGS. 13 and 17, target system (100) may include one or more drop hooks (401). As shown in FIG. 13, an exemplary drop hook (401) may include a mounting end (403) designed to fit within aperture (212) on the top plate (210) and bottom plate (211) while allowing for some play therebetween. Proximate the terminal end (403a) of mounting end (403) is an aperture (404) which is configured to receive a pin (not shown) therethrough to retain drop hook (401) within apertures (212) and prevent dislodging of drop hook (401) during travel or when moving the target system (100) on the range.

Drop hook (401) may also include a hanger end (407) configured to extend outwardly from hanger (201) when mounting end (403) is secured within apertures (212). Hanger end (407) may include a long mounting arm (405) configured to releasably receive a target, such as a steel plate, thereon. Long mounting arm (405) of drop hook (401) is dimensioned to allow the target/steel plate to slide rearward toward the hanger (201) as it is hit with bullets. The force applied by the impacting bullet may push the steel plate rearward until the plate eventually falls off drop hook (401). As such, long mounting arm (405) may create a reactive target for the shooter since, depending on shot placement, the steel plate will take more or less shots to drop off the hook.

Hanger end (407) may further include a short mounting arm (406) which is configured to mount a second steel plate onto drop hook (401) as a backstop. That is, if a user was to shoot another round after the forward oriented target plate has fallen off of long mounting arm (405) as discussed above, the second backstop plate will receive the bullet and prevent the shooter from hitting the target hanger (201) itself.

### Paper Target Holder

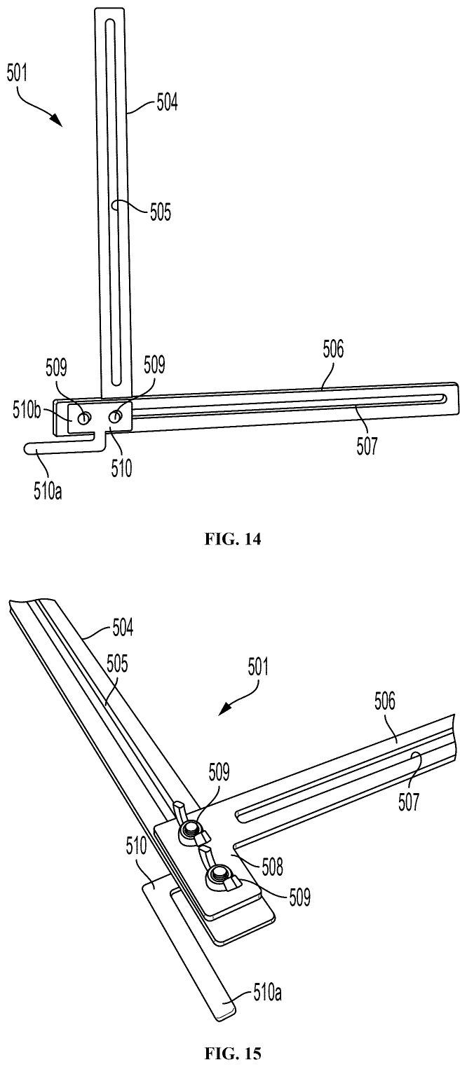

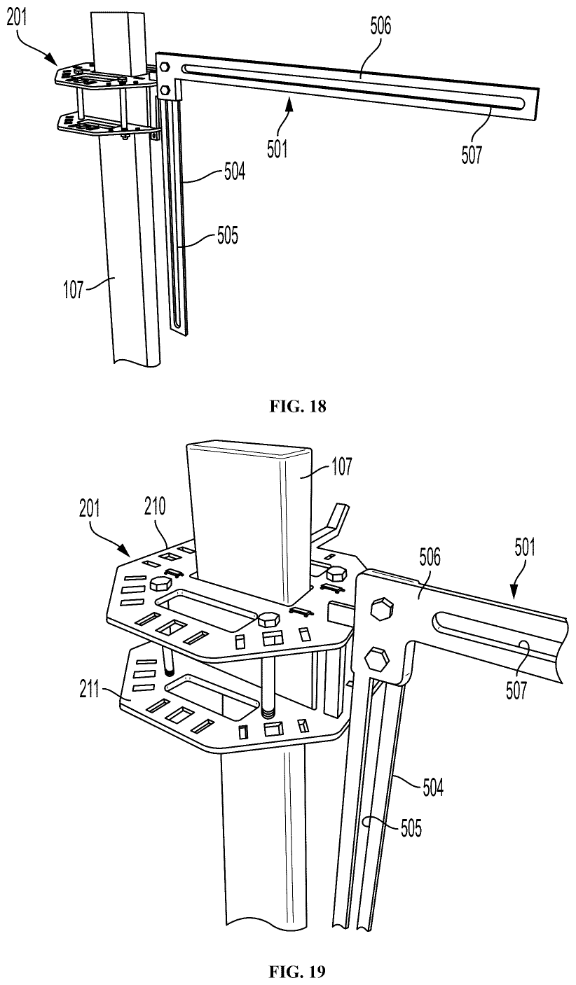

With particular reference to FIGS. 14, 15, and 18-20, target system (100) may also include one or more paper target holders (501). As shown in FIGS. 14 and 15, an exemplary paper target holder (501) may include a first rail section (504) defining a slot (505) extending along its longitudinal axis and a second rail section (506) defining a slot (507). Second rail section (506) further includes a connecting end (508) defining first and second bores configured to receive respective fasteners, e.g., bolts (509) therethrough to slidably secure second rail section (506) to first rail section (504). In one aspect of the invention, connecting end (508) is designed so that second rail section (506) to first rail section (504) are arranged generally perpendicular to one another when bolts (509) are tightened.

Paper target holder (501) may further include a hook (510) that has a mounting end (510a) that is dimensioned to be slidably received within a user selected slot (213) in target hanger (201). Hook (510) includes a connection portion (510b) having a pair of bores dimensioned and spaced apart so as to coincide with the first and second bores on connecting end (508) of second rail section (506). Bolts (509) may thus secure first rail section (504), second rail section (506) and hook (510) together as an assembly paper target holder (501). It should be noted that hook (510) may be integrally formed on second rail section (506), or be a separate component as shown.

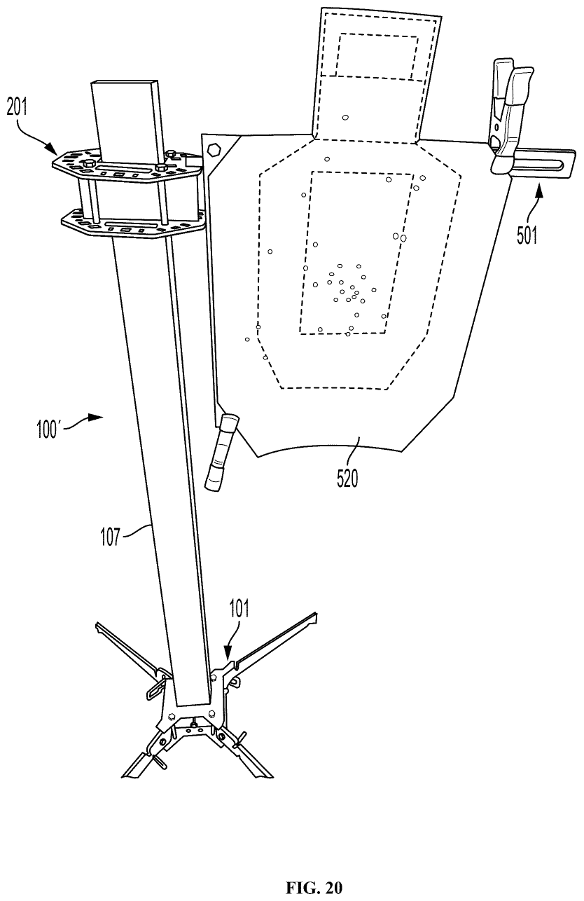

The slots (505) and (507) may be used to allow the user to adjust the height of a paper target (520), see FIG. 20, by loosening the bolts and sliding the hook portion up or down. In a further aspect of the invention, paper target hanger (501) may also fold or pivot to allow for easier storage.

### Target System Examples

FIG. 20 shows a first exemplary embodiment of a target system (100′) having a target hanger (201) mounted on a support member (107) (e.g., a 2×4) and target stand (101). Paper target holder (501) is mounted onto target hanger (201) and includes paper target (520).

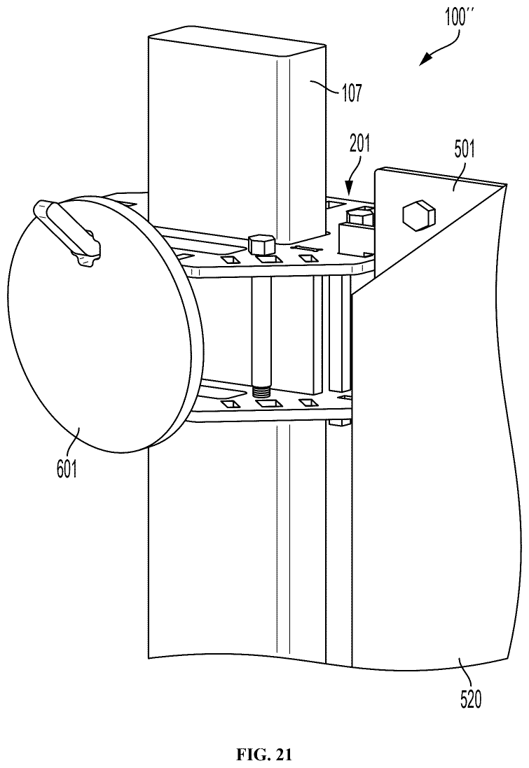

FIG. 21 shows a close up view of a second exemplary embodiment of a target system (100″) having a target hanger (201) mounted on a support member (107) (e.g., a 2×4). Paper target holder (501) is mounted onto target hanger (201) and includes paper target (520) while a target hook (301) is mounted along a second end of target hanger (201) and includes a target (601) hanging thereon. In this embodiment, target (601) is AR500 steel, but it should be noted by those skilled in the art that other targets can be used, and may be a circle or silhouette, for example.

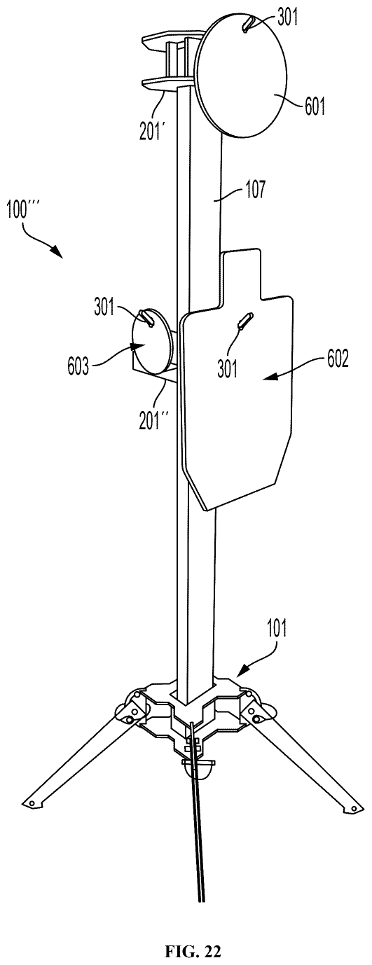

FIG. 22 shows a third exemplary embodiment of a target system (100′″) having a first target hanger (201′) and a second target hanger (201″) mounted on a support member (107) (e.g., a 2×4) and target stand (101). As shown, first target hanger (201′) is mounted proximate the top end of support member (107) while second target hanger (201″) is located intermediate the first target hanger (201′) and target stand (101). Target (601) may be mounted on first target hanger (201′) while additional targets (602, 603) may be mounted on second target hanger (201″).

### Alternative Target System

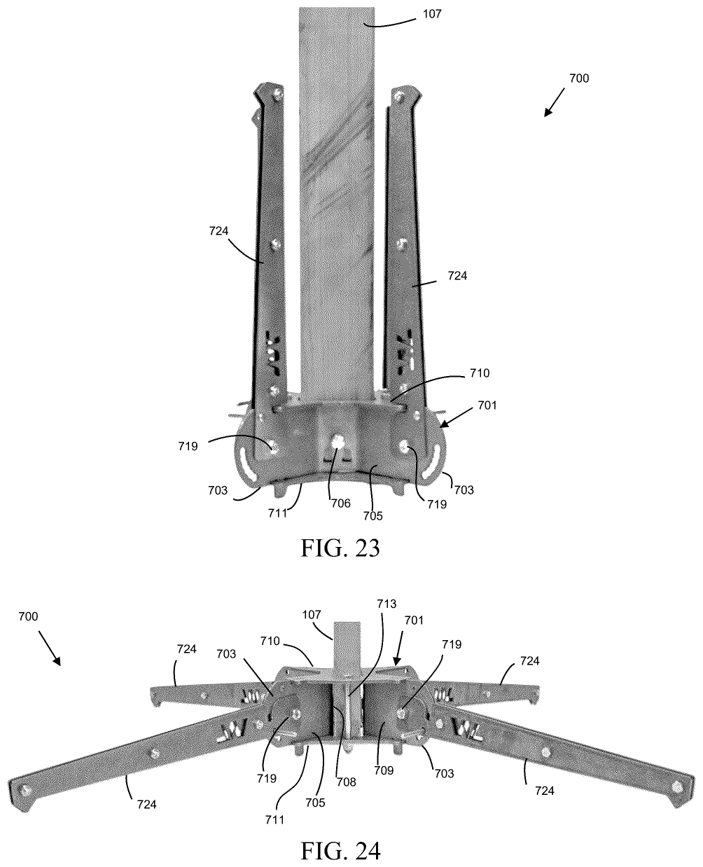

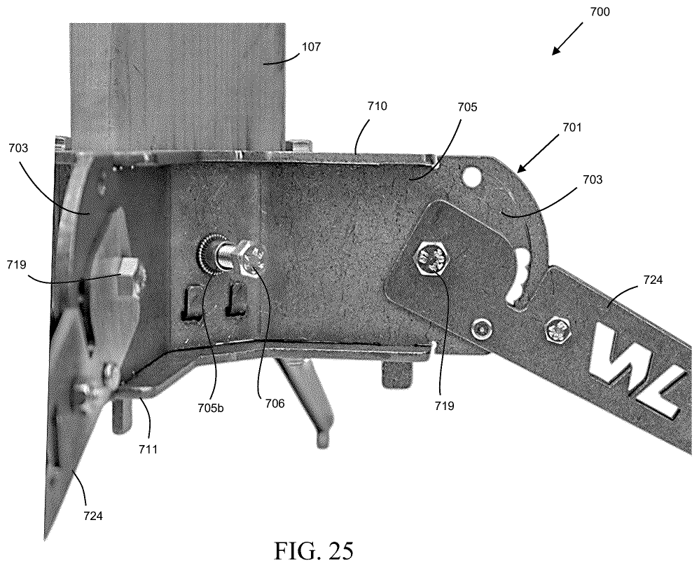

FIGS. 23-27 show an alternative exemplary embodiment of a target system (700) in accordance with a further aspect of the present invention. Target system (700) may generally include a target stand or base (701) and a target hanger (801) that may be used in conjunction with the various target hooks and mounts (301, 401, 501), described in greater detail above.

### Alternative Target Stand/Base

With reference to FIGS. 23-25, alternative exemplary target stand or base (701) is similar to target stand (101) described above and generally includes a first side plate (705) and a second side plate (709) with first side plate (705) having a drilled and tapped hole (705b) configured to removably receive a screw or bolt (706). First side plate (705) may also work in conjunction with a tension plate or spring plate (708) via bolt (706) to adjust tension on an associated support member (107), such as but not limited to a common wood 2×4. In one aspect of the invention, stand (701) may be connected along any part of support member (107). Second side plate (709) may be further customized to include branding information.

Stand (701) may further include a top plate (710) and a bottom plate (711). In one aspect, top plate (710) and bottom plate (711) may be identical to promote interchangeability and case of construction of stand (701). Each of top plate (710) and bottom plate (711) may include respective side plate slots designed to receive corresponding respective tabs on first side plate (705) and second side plate (709). Top plate (710), bottom plate (711), first side plate (705), and second side plate (709) may then be secured together, such as via one or more screws or nuts and bolts (713).

Unlike target stand (101) described above, leg bracket segments (703) of stand (701) are formed as a unitary, continuous structure with first side plate (705) and second side plate (709). Each leg bracket segment (703) may be shaped similar to a half-circle or half-ellipse. Each respective leg bracket segment (703) is used to attach a respective leg (724) to the base/stand (701). Each respective leg bracket segment (703) has a central aperture and each respective leg (724) includes a corresponding aperture configured to receive a bolt or pin (719) therethrough to pivotally mount each leg (724) onto a leg bracket (703).

### Alternative Target Hanger

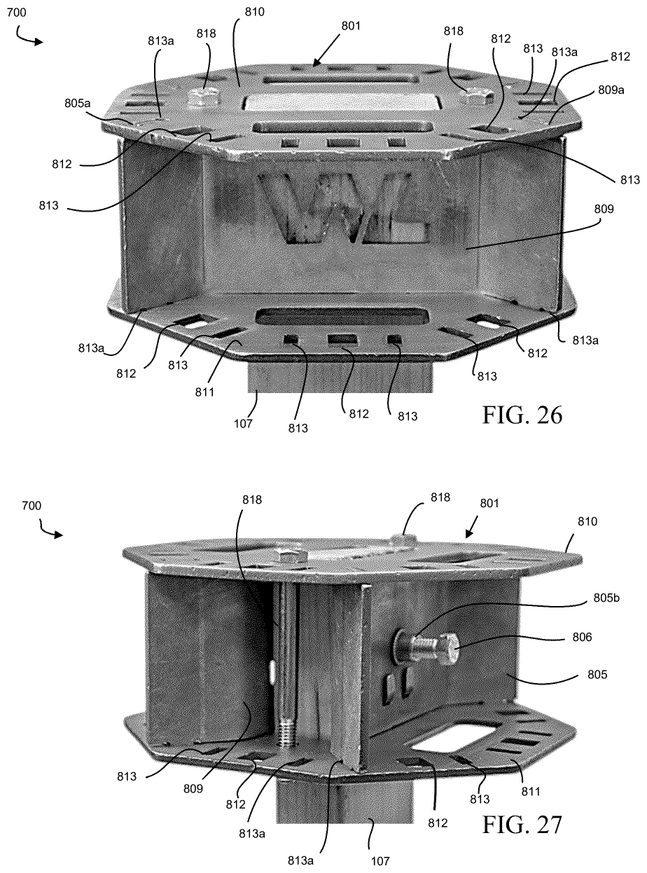

As shown FIGS. 26 and 27, target system (700) further includes a target hanger (801) which may be used to hang steel, paper, and other targets similar to target hanger (201) described above. Similar to target hanger (201), target hanger (801) comprises a hanger subassembly including a first side plate (805) and a second side plate (809). First side plate (805) may include a drilled and tapped hole (805b) configured to removably receive a screw or bolt (806). First side plate (805) works in conjunction with a tension plate or spring plate (not shown) via bolt (806) to adjust tension on an associated support member (107), such as but not limited to a common wood 2×4. In one aspect of the invention, target hanger (801) may be connected along any part of support member (107). Second side plate (809) may be further customized to include branding information.

Hanger (801) may further include a top plate (810) and a bottom plate (811). In one aspect, top plate (810) and bottom plate (811) may be identical to promote interchangeability and case of construction of hanger (801). Each of top plate (810) and bottom plate (811) may include a plurality of apertures (812), (813) proximate the side edges. Apertures (813a) are designed to receive corresponding respective tabs (805a) and (809a) on first side plate (805) and second side plate (809). Top plate (810), bottom plate (811), first side plate (805), and second side plate (809) may then be secured together, such as via one or more screws or nuts and bolts (818). In certain embodiments, 3D-printed tubes may be configured snap onto the bolts to protect the bolts from potential impacts while also preventing over-tightening of bolts (818). In one embodiment, the 3D tubes may only be printed at 80% completion of a full circle, e.g., generally C-shaped, to allow them to snap into place while target hanger (801), thus not requiring sliding the tubes onto bolts (818) prior to assembly.

### Target System

The system and apparatuses described herein provide a number of features. Without meaning to be limiting in any way, select features may include the benefit that each part, subpart or component of the target system (100), (700) is modular and replaceable. As a result, a consumer may simply replace one part if an incident or damage occurs rather than having to purchase an entire new target system. Moreover, target stand (101) and target hanger (201) share two identical side plates. As such, an opportunity to build new features and systems associated with those plates is possible depending upon, for instance, differing system requirements and/or uses, such as a more robust version for heavier steel, and the provision of reactive targets, a dedicated paper target hanger, a gun stand, a skeet thrower, or swinger targets to name a few.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable combination. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive.

What is claimed is:

1. A target hanger configured to mount one or more targets thereon, the target hanger comprising a hanger body having a top plate and a bottom plate spaced apart by a first side plate and a second side plate, the first side plate and the second side plate defining a gap therebetween configured to receive a support member therein to mount the target hanger on the support member, wherein one or both of the top plate and the bottom plate define an aperture therethrough wherein the aperture is configured to coincide with the gap to allow passage of the support member through the aperture, wherein one or both of the top plate and the bottom plate further define a plurality of slots proximate a peripheral edge of the top plate and/or the bottom plate, wherein each slot of the plurality of slots is configured to selectively receive a target mount therein to present the target to a user.

2. The target hanger of claim 1 wherein one or both of the top plate and bottom plate is an octagonal plate and wherein the plurality of slots is twenty-four wherein each edge of the octagonal plate has three slots of the plurality of slots.

3. The target hanger of claim 2 wherein a center slot of the three slots is dimensioned different than the outer two slots of the three slots.

4. The target hanger of claim 1 wherein each of the first side plate and the second side plate include one or more tabs, wherein each respective one or more tabs is configured to slidably engage with a respective slot of the plurality of slots.

5. The target hanger of claim 4 wherein the top plate is secured to the bottom plate using one or more bolts wherein the first side plate and the second side plate are constrained between the top plate and the bottom plate.

6. The target hanger of claim 1 wherein the first side plate defines a threaded aperture therethrough, the threaded aperture configured to receive a threaded bolt therein wherein the threaded blot secures the target hanger on the support member.

7. The target hanger of claim 6 further comprising a spring plate configured to be positioned between an inner surface of the first side plate and the support member, wherein the threaded bolt engages the spring plate whereby the spring plate imparts a clamping force upon the support member in conjunction with the second side plate.

8. The target hanger of claim 1 further comprising one or more target mounts selectively positionable on one or both of the top plate and the bottom plate, wherein each target mount is configured to receive the target thereon.

9. The target hanger of claim 8 wherein the one or more target mounts is one or more of a target hook, a drop hook, or a paper target holder.

10. A target system for presenting one or more targets to a user, the target system comprising:
a) a target stand configured to mount a support member thereon;
b) a target hanger comprising a hanger body having a top plate and a bottom plate spaced apart by a first side plate and a second side plate, the first side plate and the second side plate defining a gap therebetween configured to receive the support member therein to mount the target hanger on the support member a spaced distance from the target stand, wherein one or both of the top plate and the bottom plate define an aperture therethrough wherein the aperture is configured to coincide with the gap to allow passage of the support member through the aperture, wherein one or both of the top plate and the bottom plate further define a plurality of slots proximate a peripheral edge of the top plate and/or the bottom plate, wherein each slot of the plurality of slots is configured to selectively receive a target mount therein to present the target to a user; and
c) one or more target mounts selectively positionable on one or both of the top plate and the bottom plate, wherein each target mount is configured to receive at least one target of the one or more target thereon.
